(19) United States
(12) Patent Application Publication
(10) Pub. No.: US 2007/0140218 A1
(43) Pub. Date: Jun. 21, 2007

(54) Managing backhaul connections in radio access networks

(76) Inventors: Girish R. Nair, Nashua, NH (US); Suresh Ramaswamy, Chelmsford, MA (US); Woojune Kim, Arlington, MA (US); Dennis Ng, Northboro, MA (US)

Correspondence Address: FISH & RICHARDSON PC, P.O. BOX 1022, MINNEAPOLIS, MN, 55440-1022, US

(21) Appl. No.: 11/305,285

(22) Filed: Dec. 16, 2005

(51) Int. Cl. H04L 12/66

(52) U.S. Cl. 370/352

(57) ABSTRACT

Techniques for initiating a backhaul connection between a radio node controller and a packet data serving node of a radio access network based on a determination of a presence of a packet data session on an access terminal. Techniques for enabling a dormant access terminal in communication with a radio access network to maintain a point-to-point (PPP) session with a packet data serving node as the dormant access terminal moves from a coverage area associated with a first radio node controller to a coverage area associated with a second radio node controller prior to a completion of a backhaul connection setup by the first radio node controller.

### TECHNICAL FIELD

This description relates to managing backhaul connections in radio access networks.

### BACKGROUND

High Data Rate (HDR) is an emerging mobile wireless access technology that enables personal broadband Internet services to be accessed anywhere, anytime (see P. Bender, et al., “CDMA/HDR: A Bandwidth-Efficient High-Speed Wireless Data Service for Nomadic Users”, IEEE Communications Magazine, July 2000, and 3GPP2, “Draft Baseline Text for 1xEV-DO,” Aug. 21, 2000). Developed by Qualcomm, HDR is an air interface optimized for Internet Protocol (IP) packet data services that can deliver a shared forward link transmission rate of up to 2.46 Mbit/s per sector using only (1×) 1.25 MHz of spectrum. Compatible with CDMA2000 radio access (TIA/EIA/IS-2001, “Interoperability Specification (IOS) for CDMA2000 Network Access Interfaces,” May 2000) and wireless IP network interfaces (TIA/EIA/TSB-115, “Wireless IP Architecture Based on IETF Protocols,” Jun. 6, 2000, and TIA/EIA/IS-835, “Wireless IP Network Standard,” 3rd Generation Partnership Project 2 (3GPP2), Version 1.0, Jul. 14, 2000), HDR networks can be built entirely on IP technologies, all the way from the mobile Access Terminal (AT) to the global Internet, thus taking advantage of the scalability, redundancy and low-cost of IP networks.

An EVolution of the current 1xRTT standard for high-speed data-only (DO) services, also known as the 1xEV-DO protocol has been standardized by the Telecommunication Industry Association (TIA) as TIA/EIA/IS-856, “CDMA2000 High Rate Packet Data Air Interface Specification”, 3GPP2 C.S0024-0, Version 4.0, Oct. 25, 2002, which is incorporated herein by reference. Revision A to this specification has been published as TIA/EIA/IS-856, “CDMA2000 High Rate Packet Data Air Interface Specification”, 3GPP2 C.S0024-A, Version 2.0, June 2005, Ballot Resolution, but has yet not been adopted. Revision A is also incorporated herein by reference. TIA/ELI/878-1, “Inter-Operability Specification (IOS) for High Rate Packet Data (HPRD) Access Network Interfaces”, 3GPP2 A.S0008-0, Version 3.0, May 2003, is also incorporated herein by reference.

FIG. 1 shows a 1xEV-DO radio access network 100 with radio node controllers RNC-1 to RNC-3 connected to radio nodes RN-1 to RN-12 over a packet network 102. The packet network 102 can be implemented as an IP-based network that supports many-to-many connectivity between the radio nodes RN-1 to RN-12 and the radio node controllers RNC-1 to RNC-3. The packet network 102 is connected to the Internet 104 via a packet data serving node (PDSN) 106. Other radio nodes, radio node controllers, packet networks, and packet data serving nodes (not shown in FIG. 1) can be included in the radio access network 100.

In order for an access terminal 108 (e.g., a laptop computer, a Personal Digital Assistant (PDA), a dual-mode voice/data handset, or another device, with built-in 1xEV-DO support) to connect to the Internet 104, two connection legs and a point-to-point (PPP) session have to be established. One connection leg involves an airlink connection between the access terminal 108 and a radio node of the network 100, and another connection leg involves a backhaul connection between a radio node controller of the network 100 and the PDSN 106.

Initially, the access terminal 108 exchanges messages with a radio node controller (e.g., RNC-1) to negotiate session configuration parameters. Once a 1xEV-DO session is established for the access terminal 108 on the network 100, the RNC-1 opens a wired backhaul connection (also referred to in this description as an A10 connection 110) with the PDSN 106. The establishment of the A10 connection 110 triggers the PDSN 106 to attempt a point-to-point (PPP) session setup with the access terminal 108 by sending PPP Link Control Protocol (LCP) Config Request packets to the RNC-1, which in turn attempts to page the access terminal 108 to setup an airlink connection (also referred to in this description as a DO connection 112). If the access terminal 108 does not have a packet data session, the PPP session setup attempt will eventually time out, and the PDSN 106 will tear down the A10 connection 110.

The establishment of the A10 connection without regard as to the state of the access terminal 108 (i.e., without the RNC-1 knowing whether the access terminal 108 has a packet data session) leads to inefficient network utilization in terms of PDSN 106, the RNC-1, and airlink resources. However, network operators often choose to implement the radio node controllers of the network 100 to automatically open the A10 connection whenever a 1xEV-DO session is set up in order to err on the side of providing service to the access terminal 108.

In other cases, network operators may choose to implement the radio node controllers of the network 100 to open the A10 connection only if the access terminal 108 is in an active state. While network resources are more efficiently utilized in such cases, other problems related to access terminals 108 with dormant packet data sessions may arise as such access terminals 108 are un-reachable by the network 100 even though the access terminals have dormant packet data sessions present.

When a dormant access terminal 108 moves from the coverage area of RNC-1 into the coverage area of RNC-2 after the RNC-1 has opened the A10 connection, the RNC-1 is typically implemented to respond to an A13 Request message sent by RNC-2 with an A13 Response message that includes at least the following: (a) session configuration parameters associated with the access terminal's 1xEVDO session established on RNC-1; and (b) an Internet Protocol address associated with the PDSN with which the RNC-1 has established the A10 connection. The RNC-2 uses the session configuration parameters retrieved from the RNC-1 to establish a new session at RNC-2 and uses the IP address provided in the A13 Response message as a trigger to open an A10 connection for that access terminal 108 with the PDSN. If the dormant access terminal 108 moves back into the coverage area of RNC-1 before the RNC-2 has completed the A10 connection setup, the RNC-2 will respond to an A13 Request message sent by RNC-1 with an A13 Response message that only includes the session configuration parameters associated with the access terminal's 1xEVDO session established on RNC-2. The trigger to open the A10 connection is lost when the dormant access terminal ping-pongs rapidly back to the coverage area of RNC-1. This results in the access terminal 108 being un-reachable by the network 100 even though the access terminal has a dormant packet data session present.

### SUMMARY

In one aspect, the invention features a method that includes initiating a backhaul connection between a radio node controller and a packet data serving node of a radio access network based on a determination of a presence of a packet data session on an access terminal.

Implementations of the invention may include one or more of the following. The method may include determining the presence of a packet data session on the access terminal based on trigger information. The trigger information may include receipt of a packet from the access terminal on a reverse communication link (e.g., a reverse traffic channel of an airlink connection) of the network. The trigger information may include receipt of a type of message from the access terminal. The type of message may be a location update message (e.g., a 1xEV-DO unsolicited location notification message). The type of message may be an airlink connection setup request message. The trigger information may include receipt of a message from a second radio node controller. The message may include an Internet Protocol address (e.g., a non-zero Internet Protocol address associated with a packet data serving node of the network). The message may include session configuration parameters associated with a session at the second radio node controller.

The method may include establishing the backhaul connection between the radio node controller and the packet data serving node. The method may include closing a backhaul connection between the radio node controller and a second different packet data serving node of the network.

In another aspect, the invention features an apparatus that includes a processor, and a memory having software to provide instructions to the processor to determine a presence of a packet data session on an access terminal in communication with the apparatus and to initiate a backhaul connection between the apparatus and a packet data serving node of a radio access network based on the determination.

In another aspect, the invention features an apparatus that includes means for initiating a backhaul connection between a radio node controller and a packet data serving node of a radio access network based on a determination of a presence of a packet data session on an access terminal.

In another aspect, in a radio access network including radio node controllers and a packet data serving node, the invention features a method that includes enabling a dormant access terminal in communication with the network to maintain a point-to-point (PPP) session with the packet data serving node as the dormant access terminal moves from a coverage area associated with a first radio node controller to a coverage area associated with a second radio node controller prior to a completion of a backhaul connection setup by the first radio node controller.

Implementations of the invention may include one or more of the following.

At the first radio node controller, the method includes receiving a dormant handoff request message from the second radio node controller, determining whether a trigger to open a backhaul connection between the first radio node controller and the packet data serving node has been received, and taking an action based on the determination. The method of taking an action may include sending a dormant handoff response message to the second radio node controller. The dormant handoff response message may include an Internet Protocol address (e.g., an Internet Protocol address associated with the packet data serving node).

At the second radio node controller, the method includes receiving a dormant handoff response message from the first radio node controller, determining whether a trigger to open a backhaul connection between the first radio node controller and the packet data serving node has been received, and taking an action based on the determination. The method of taking an action may include initiating a backhaul connection with the packet data serving node.

At the second radio node controller, the method includes receiving a message from the first radio node controller that includes a trigger to open a backhaul connection with a network component.

The method may include enabling the dormant access terminal to maintain the PPP session with the packet data serving node as the dormant access terminal moves from the coverage area associated with the second radio node controller to a coverage area associated with the first radio node controller or a third radio node controller prior to a completion of a backhaul connection setup by the second radio node controller.

In another aspect, the invention feature a system that includes a packet data serving node, and radio node controllers to enable a dormant access terminal in communication with the network to maintain a point-to-point (PPP) session with the packet data serving node as the dormant access terminal moves from a coverage area associated with a first of the radio node controllers to a coverage area associated with a second of the radio node controllers prior to a completion of a backhaul connection setup by the first of the radio node controllers.

Implementations of the invention may include one or more of the following.

The first of the radio node controllers may receive a dormant handoff request message from the second of the radio node controllers, and in response to the dormant handoff request message, send a dormant handoff response message including an Internet Protocol address to the second of the radio node controllers if a trigger to open a backhaul connection between the first of the radio node controllers and the packet data serving node has been received. The Internet Protocol address may be associated with the packet data serving node.

The details of one or more examples are set forth in the accompanying drawings and the description below. Further features, aspects, and advantages of the invention will become apparent from the description, the drawings, and the claims.

### DESCRIPTION OF DRAWINGS

FIG. 1 shows a radio access network.

FIGS. 2 and 3 each show a call flow diagram.

### DETAILED DESCRIPTION

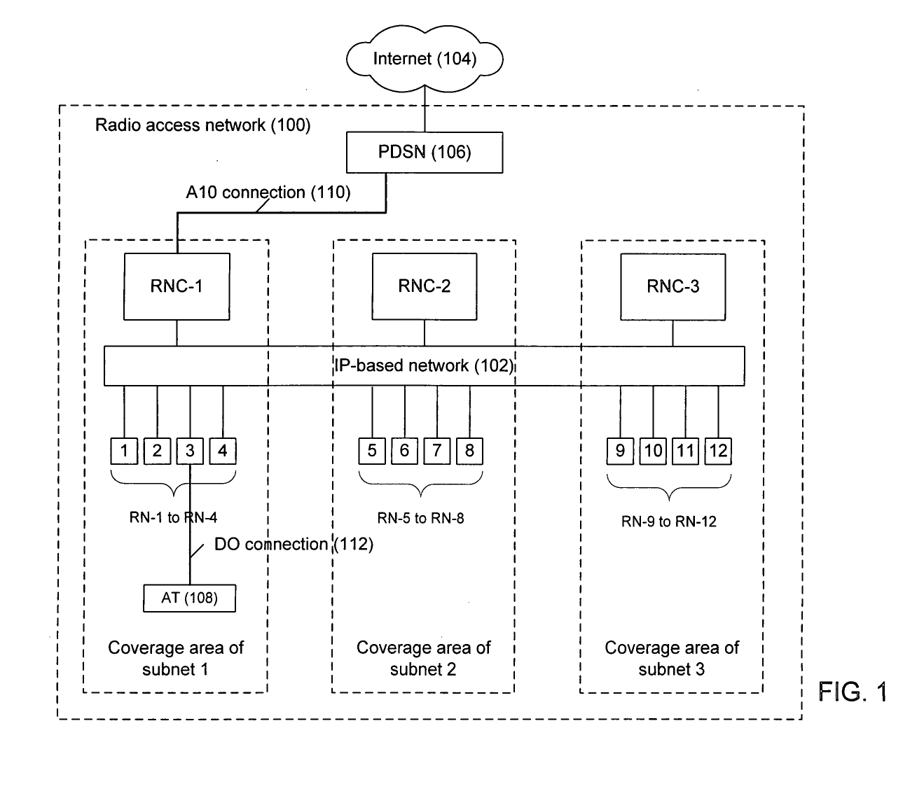

A radio node controller of the 1xEV-DO radio access network 100 of FIG. 1 can support one or more of the following: an A10 connection setup minimization feature and an A10 connection setup trigger preservation feature.

### A10 Connection Setup Minimization

In some implementations, a radio node controller of the 1xEV-DO radio access network 100 of FIG. 1 supports an A10 connection setup minimization feature in which the radio node controller initiates an A10 connection setup with the PDSN 106 only in those instances in which a positive identification of a presence of a packet data session on an access terminal 108 served by the radio node controller has been made.

There are a number of different ways in which the radio node controller (e.g., RNC-1) can make such a positive identification. In some cases, the radio node controller RNC-1 uses receipt of a message on a particular communication channel between an access terminal 108 and the network 100 as a trigger to initiate an A10 connection setup. For example, the radio node controller RNC-1 can infer from the receipt of packets transmitted by the access terminal 108 on a reverse traffic channel of a DO connection 112 that an active packet data session is present on the access terminal 108, and initiate an A10 connection setup with the PDSN 106 to establish (or open) an A10 connection 110. The packets are buffered at the radio node controller RNC-1 and sent on the A10 connection 110 once the A10 connection 110 is opened.

In some cases, the radio node controller RNC-1 uses receipt of a certain type of message transmitted by the access terminal 108 as a trigger to initiate an A10 connection setup. For example, when an access terminal 108 in compliance with TIA/EIA/IS-856 is configured with a RANHandoff attribute of 0x01, the access terminal 108 sends an Unsolicited Location Notification (ULN) message to the network 100 if a packet data session is present during the following instances: (1) a dormant handoff between subnets followed by session configuration in the target subnet; or (2) the access terminal 108 moves from a 1xRTT network to a 1xEV-DO network. Accordingly, the radio node controller RNC-1 can be configured to initiate an A10 connection setup with the PDSN 106 upon receipt of a ULN message.

In some cases, the radio node controller RNC-1 uses a certain event as a trigger to initiate an A10 connection setup. For example, if an access terminal 108 established a 1xEV-DO session with the network 100 while operating in an idle state, detection of a user input to start a packet data session at any point after will result in the access terminal 108 sending a Connection Setup Request message to the network 100. Upon receipt of the Connection Setup Request message, the radio node controller RNC-1 establishes a DO connection 112 with the access terminal 108, and uses the access terminal initiated DO Connection opening event as a trigger to initiate an A10 connection setup with the PDSN 106.

In some cases, the radio node controller uses a certain event and condition as a trigger to initiate an A10 connection setup. For example, when an access terminal 108 with a dormant session (“S1”) established on one radio node controller (e.g., RNC-1) moves into a coverage area of a subnet associated with another radio node controller (e.g., RNC-2), the access terminal 108 sends a UATI (unicast access terminal identifier) Request message including a foreign UATI on the access channel of a sector associated with the new subnet. RNC-2 responds to the message by sending an A13 Request message (“A13 Request message A”) to RNC-1, which returns session configuration parameters associated with S1 in an A13 Response message (“A13 Response message A”). In those instances in which an A10 connection 110 is opened between RNC-1 and the PDSN 106, RNC-1 includes an IP address (e.g., the IP address of the PDSN 106, or a dummy IP address that is not associated with any component of the network 100) in the A13 Response message A. RNC-2 uses the session configuration parameters retrieved from RNC-1 to establish a new session (“S2”) on RNC-2 for the access terminal 108, and uses the IP address provided in the A13 Response message A as a trigger to initiate an A10 connection setup with a PDSN (in this case, PDSN 106).

By eliminating the establishment of unnecessary A10 connections, resource usage on the radio node controllers and the PDSN can be minimized. This leads to a higher DO connection setup success rate and a lower DO connection drop rate. By initiating an A10 connection setup only in those instances in which a packet data session (active or dormant) is present on an access terminal, the PPP success rate is increased as the access terminal has the capability of responding to the PPP session setup attempts by the PDSN 106.

### A10 Connection Setup Trigger Preservation

In some implementations, a radio node controller of the 1xEV-DO radio access network 100 of FIG. 1 supports a feature in which an A10 connection setup trigger is preserved in those instances in which a dormant access terminal, at or near a subnet boundary, causes ping-pongs to occur by moving back and forth between neighboring subnets. Generally, a ping-pong is said to occur when a dormant access terminal moves from a coverage area of a first radio node controller to a coverage area of a second radio node controller, and then back to a coverage area of the first radio node controller or onto a coverage area of a third radio node controller, prior to a completion of an A10 connection setup by the second radio node controller. Two example ping-pong scenarios are described below.

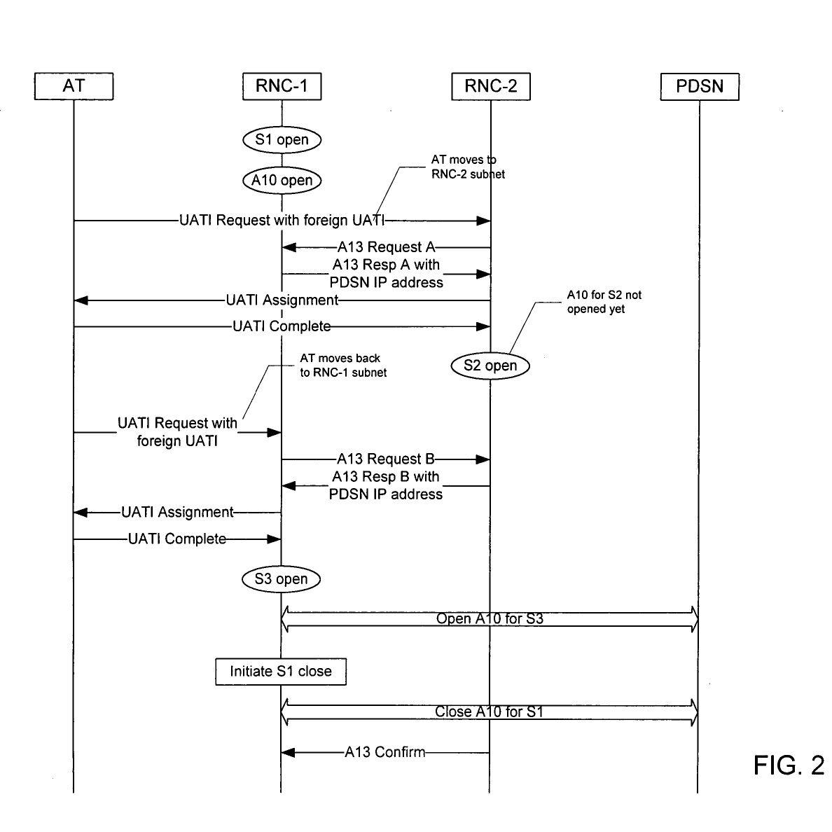

Referring to FIGS. 1 and 2, in one example ping-pong scenario, suppose the access terminal 108 moves from the RNC-1 subnet to the RNC-2 subnet and then back to the RNC-1 subnet after a UATI complete message has been received at RNC-2 but prior to the A10 connection 110 with the PDSN 106 being initiated by or opened on the RNC-2. When the access terminal 108 crosses the subnet boundary, it sends a UATI Request message including a foreign UATI to RNC-1 (assigned by RNC-2), which triggers RNC-1 to initiate an A13 dormant handoff by sending an A13 Request message (“A13 Request message B”) to the RNC-2 requesting the session configuration parameters associated with S2. The RNC-2 can be implemented to respond to the A13 Request message B with an A13 Response message (“A13 Response message B”) that includes the IP address provided in the A13 Response message A. Upon receipt of the A13 Response message B, the RNC-1 uses the session configuration parameters retrieved from the RNC-2 to establish a new session (“S3”) at RNC-1 and uses the IP address provided in the A13 Response message B as a trigger to open an A10 connection for that access terminal 108 with a PDSN (in this case, PDSN 106). In some implementations, the RNC-1 delays closing the original A10 connection until after the new A10 connection is opened for the session S3. This ensures that the PDSN PPP session is not lost.

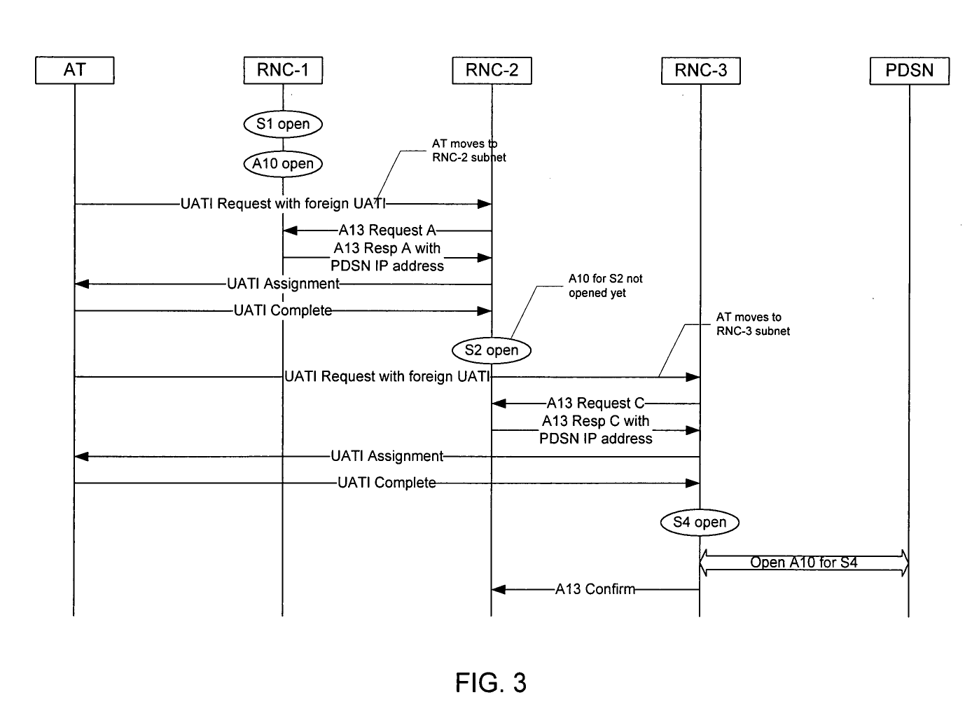

Referring to FIGS. 1 and 3, in another example scenario, rather than moving into the RNC-1 subnet, suppose the access terminal 108 in the RNC-2 subnet moves into a subnet associated with another radio node controller (e.g., RNC-3) after a UATI complete message has been received from the access terminal 108 but prior to the A10 connection with the PDSN being opened on the RNC-2. Upon receipt of a UATI Request message including a foreign UATI, the RNC-3 initiates an A13 dormant handoff by sending an A13 Request message (“A13 Request message C”) to the RNC-2 requesting the session configuration parameters associated with S2. The RNC-2 can be implemented to respond to the A13 Request message C with an A13 Response message (“A13 Response message C”) that includes the IP address provided in the A13 Response message A by the RNC-1. Upon receipt of the A13 Response message C, the RNC-3 uses the session configuration parameters retrieved from the RNC-2 to establish a new session (“S4”) and uses the IP address provided in the A13 Response message C as a trigger to open an A10 connection for that access terminal 108 with a PDSN (in this case, the PDSN 106).

By enabling a radio node controller to send a IP address to another radio node controller in order to preserve an A10 connection setup trigger, an access terminal located in an area that straddles the boundaries or borders between two subnets is able to maintain its network connectivity with the network in rapid mobility cases or in cases in which fast ping-pongs between subnets take place due to poor or changing RF conditions. By ensuring that the PDSN PPP session is retained on the access terminal, there is no need for the PDSN to attempt a PPP session setup with the access terminal after the A10 connection has been established. This in turn has the effect of conserving airlink and network resources that are typically used when the radio node controller has to page the access terminal in order to transmit the PPP LCP packets.

Although the techniques described above employ the 1xEV-DO air interface standard, the techniques are also applicable to other CDMA and non-CDMA air interface technologies. Further, messages other than those depicted in the call flows of FIGS. 2 and 3 may be passed between various components of the network 100.

The techniques described above can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

A number of embodiments of the invention have been described. Nevertheless, it will be understood that various modifications may be made without departing from the spirit and scope of the invention, and, accordingly, other embodiments are within the scope of the following claims.

What is claimed is:

1. A method comprising:
initiating a backhaul connection between a radio node controller and a packet data serving node of a radio access network based on a determination of a presence of a packet data session on an access terminal.

2. The method of claim 1, further comprising:
determining the presence of a packet data session on the access terminal based on trigger information.

3. The method of claim 2, wherein the trigger information comprises receipt of a packet from the access terminal on a reverse communication link of the network.

4. The method of claim 3, wherein the reverse communication link comprises a reverse traffic channel of an airlink connection between the access terminal and the network.

5. The method of claim 2, wherein the trigger information comprises receipt of a type of message from the access terminal.

6. The method of claim 5, wherein the type of message comprises a location update message.

7. The method of claim 6, wherein the location update message comprises a 1xEV-DO unsolicited location notification message.

8. The method of claim 5, wherein the type of message comprises an airlink connection setup request message.

9. The method of claim 2, wherein the trigger information comprises receipt of a message from a second radio node controller.

10. The method of claim 9, wherein the message comprises an Internet Protocol address.

11. The method of claim 10, wherein the Internet Protocol address is associated with the packet data serving node.

12. The method of claim 9, wherein the message comprises session configuration parameters associated with a session at the second radio node controller.

13. The method of claim 1, further comprising:
establishing the backhaul connection between the radio node controller and the packet data serving node.

14. The method of claim 1, further comprising:
closing a backhaul connection between the radio node controller and a second different packet data serving node of the network.

15. An apparatus comprising:
a processor; and
a memory including software to provide instructions to the processor to determine a presence of a packet data session on an access terminal in communication with the apparatus and to initiate a backhaul connection between the apparatus and a packet data serving node of a radio access network based on the determination.

16. An apparatus comprising:
means for initiating a backhaul connection between a radio node controller and a packet data serving node of a radio access network based on a determination of a presence of a packet data session on an access terminal.

17. A method comprising:
in a radio access network comprising radio node controllers and a packet data serving node, enabling a dormant access terminal in communication with the network to maintain a point-to-point (PPP) session with the packet data serving node as the dormant access terminal moves from a coverage area associated with a first radio node controller to a coverage area associated with a second radio node controller prior to a completion of a backhaul connection setup by the first radio node controller.

18. The method of claim 17, wherein the enabling comprises:
at the first radio node controller,
receiving a dormant handoff request message from the second radio node controller, determining whether a trigger to open a backhaul connection between the first radio node controller and the packet data serving node has been received, and taking an action based on the determination.

19. The method of claim 18, wherein taking an action comprises:
sending a dormant handoff response message to the second radio node controller, wherein the dormant handoff response message comprises an Internet Protocol address.

20. The method of claim 19, wherein the Internet Protocol address is associated with the packet data serving node.

21. The method of claim 17, wherein the enabling comprises:
at the second radio node controller,
receiving a dormant handoff response message from the first radio node controller, determining whether a trigger to open a backhaul connection between the first radio node controller and the packet data serving node has been received, and taking an action based on the determination.

22. The method of claim 21, wherein taking an action comprises:
initiating a backhaul connection with the packet data serving node.

23. The method of claim 17, wherein the enabling comprises:
at the second radio node controller, receiving a message from the first radio node controller that includes a trigger to open a backhaul connection with a network component.

24. The method of claim 17, further comprising:
enabling the dormant access terminal to maintain the PPP session with the packet data serving node as the dormant access terminal moves from the coverage area associated with the second radio node controller to a coverage area associated with a third radio node controller prior to a completion of a backhaul connection setup by the second radio node controller.

25. The method of claim 17, further comprising:
enabling the dormant access terminal to maintain the PPP session with the packet data serving node as the dormant access terminal moves from the coverage area associated with the second radio node controller back to the coverage area associated with the first radio node controller prior to a completion of a backhaul connection setup by the second radio node controller.

26. A system comprising:
a packet data serving node; and
radio node controllers to enable a dormant access terminal in communication with the network to maintain a point-to-point (PPP) session with the packet data serving node as the dormant access terminal moves from a coverage area associated with a first of the radio node controllers to a coverage area associated with a second of the radio node controllers prior to a completion of a backhaul connection setup by the first of the radio node controllers.

27. The system of claim 26 in which the first of the radio node controllers is to:
receive a dormant handoff request message from the second of the radio node controllers; and
in response to the dormant handoff request message, send a dormant handoff response message including an Internet Protocol address to the second of the radio node controllers if a trigger to open a backhaul connection between the first of the radio node controllers and the packet data serving node has been received.

28. The system of claim 27, wherein the Internet Protocol address is associated with the packet data serving node.
